(19) United States
(12) Patent Application Publication
(10) Pub. No.: US 2017/0004419 A1
(43) Pub. Date: Jan. 5, 2017

(54) SYSTEM, METHOD AND APPLICATION FOR LOCATING POTENTIAL TRAVEL COMPANIONS

(71) Applicants: Matthew Kuhlmeier, Old Tappan, NJ (US); Mary Kuhlmeier, Old Tappan, NJ (US)

(72) Inventors: Matthew Kuhlmeier, Old Tappan, NJ (US); Mary Kuhlmeier, Old Tappan, NJ (US)

(21) Appl. No.: 15/201,677

(22) Filed: Jul. 5, 2016

Related U.S. Application Data
(60) Provisional application No. 62/188,056, filed on Jul. 2, 2015.

(51) Int. Cl. G06Q 10/02; H04L 12/58; G06F 3/0482; H04L 29/08

(52) U.S. Cl. CPC G06Q 10/02; H04L 67/306; H04L 67/18; H04L 51/046; G06F 3/0482

(57) ABSTRACT

A system, method, and application user interface providing functionality for a user to locate potential travel companions. This application allows the user to be in contact with potential travel companions as soon as they log in. Users of the application are comprised of a community specifically looking to find a travel/event companion or relocate to another place with someone.

### CROSS-REFERENCE TO RELATED APPLICATION

This application claims the benefit of priority of U.S. provisional application No. 62/188,056, filed Jul. 2, 2015, the contents of which are herein incorporated by reference.

### BACKGROUND OF THE INVENTION

The present invention relates to travel and events and, more particularly, to a system, method, and application to locate a travel/event companion.

It is far too difficult for people to locate travel/event companions and have communication with each other. It is equally or even more difficult to access a medium for people looking to relocate to other areas.

Other means of locating a travel companion or someone to relocate with do not cater to that exact need. Previously, if a person wanted to find a travel companion or someone looking to relocate, they had to simply ask around. They might put out an ad or search various travel blogs on the internet. But they could not find a platform that catered to exactly what they were looking for, namely a travel companion.

As can be seen, there is a need for a system and method allows a user to be in contact with potential travel companions quickly and conveniently.

### SUMMARY OF THE INVENTION

In one aspect of the present invention, an application user interface for a mobile computing device, includes: a location banner dynamically presenting a visual image of a landmark based on a determined geographic location of the mobile computing device and a current weather summary corresponding to the determined geographic location; a control banner displaying a plurality of control buttons, each of the plurality of control buttons providing user access to a contacts module, a calendar module, a book hotel module; and a messaging module; and a top topics banner displaying a plurality of topics of interest to the user, based on comparison of a user profile and an artificial intelligence (AI) module. The visual image may provide a background for the location banner and the control banner.

In some embodiments, the UI may also include a contacts module presenting one or more possible connections based upon the user profile and recommendations of the AI module. The contacts module may be configured to permit the user to select and message a companion to invite the companion to one or more of: a travel destination, an event, or a relocation place. The contacts module may also be configured to provide functionality to display one or more potential companions based on the determined geographic location of the user and an associated geographic location of the one or more potential companions. The booking module provides functionality to book a hotel room from one of a plurality of destination hotels.

Other aspects of the invention include a system for connecting a community of users who are seeking a travel companion. The system includes: a computer; and a program product comprising machine-readable program code for causing, when executed, the computer to perform the following process steps: 1) determining a geographic location for the computer; 2) locating a visual image of a landmark associated with the geographic location; 3) determining a current weather condition of the geographic location; 4) displaying a dynamically updated location banner on a display of the computer, the location banner presenting the visual image of the landmark and a summary of the current weather condition; 5) displaying a control banner having a plurality of control buttons, each of the plurality of control buttons providing user access to a contacts module, a calendar module, a book hotel module; and a messaging module; and 6) displaying a top topics banner having a plurality of topics of interest to the user, based on comparison of a user profile and an analysis of the user's behavior when interacting with the system. In some embodiments, responsive to an activation of a contacts control button, the system presents one or more possible connections based upon the user profile and the analysis of the user's behavior. Also, responsive to a selection of a connection the system may also provide a messaging module permitting the user to message a companion to invite them to one or more of: a travel destination, an event, or a relocation place. The system may also be configured to display one or more potential companions based on the geographic location and an associated geographic location of the one or more potential companions.

In yet other aspects of the invention, the system may also be configured to present a booking module; receive a plurality of booking parameters via the booking module; and present a destination hotel corresponding to the plurality of booking parameters. The system may also receive a selection of a destination hotel and book a room at the destination hotel selection.

These and other features, aspects and advantages of the present invention will become better understood with reference to the following drawings, description and claims.

### BRIEF DESCRIPTION OF THE DRAWINGS

FIG. 1 is a flowchart illustrating aspects of the application.

FIG. 2 is a continuation of the flowchart of FIG. 1.

FIG. 3 is a schematic view of a home screen of the present application.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention, provides a system, method and application that allows the user to be in contact with potential travel companions as soon as they log in. People that own this application are specifically looking to find a travel/event companion. In some embodiments, the invention may be utilized to find a companion to relocate to another place, such as a distant city to live.

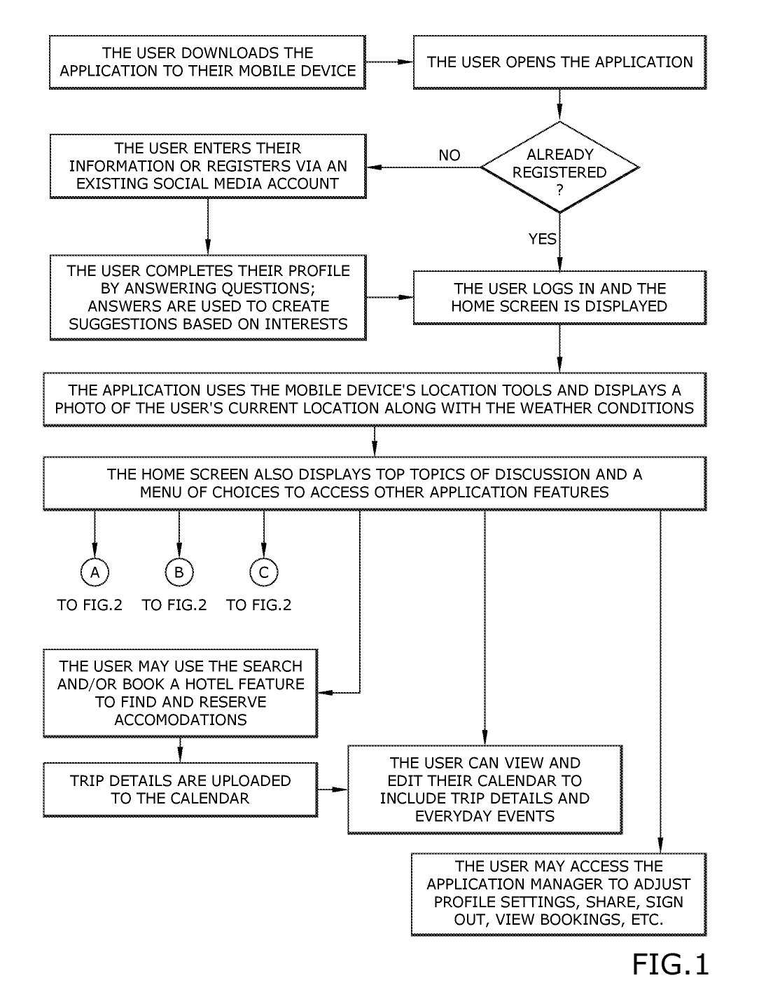

As seen in reference to FIG. 1, a software application to implement the system and method may be downloaded to a users' computing device, which may be a smartphone, a tablet, or other mobile computing device 10. The mobile computing device is preferably provisioned with a location sensing system, such as a global positioning system (GPS). The application configures the computing device to present a graphical user interface (GUI) 12, which the user will use to launch and control every element of the system and method. The GUI 12 is presented on a visual display in communication with the computing device. Preferably, the display is a touch screen device.

Once a user has launched the application, the system performs a validation to determine whether the user is previously registered with the system. If the user is not registered with the system, the system activates an account registration module, that permits the user to register as a user of the system. The registration module may prompt the user to enter specified demographic and identification data, that is stored or associated with in a user profile. For example, registering may include entry of an e-mail address associated with the user, creating a username, a password, a security question with an answer, and uploading a picture that may be associated with the user's profile. In certain embodiments, the registration module may also permit the user to register utilizing their credentials for one or more social media sites, such as Facebook, Google, or Twitter.

Once the user has registered, the system will then execute a profile builder module that presents a UI that permits the user to create or edit their profile. The profile builder module will prompt the user with questions that the user will then answer for creating their profile. As the user responds to questions, the profile builder module will analyze the user's selections and present one or more suggestions, based upon the user's selected and designated interests. An interests engine may also be configured with and Artificial Intelligence (AI) module to recognize user behavior and make recommendations for travel, activities, or events, based upon that behavior.

Combined with the questionnaire filled out by the user during the registration process and the user's behavior once exploring the app, the suggestions based upon interests feature AI recognizes that behavior and begins making recommendations to the user based on that behavior. Recommendations include connection suggestions on potential travel companions, or top topics suggestions on the feed the user may find with interest. The application software is built and set up in order to assist the user in finding exactly what they are looking for: travel/relocation/event companions, great hotel rates, social events at their desired destinations, etc.

By way of non-limiting example, the questions may include: how often they travel, reason for traveling, favorite and dream destinations, favorite hotels, favorite time of year to travel, favorite topics in regards to traveling and will also provide a section for them to describe themselves and what they are seeking. Their profile is now set up for them as well, so they can begin using all of the features. Once a user has completed their profile, or during a subsequent access to the system, the user only needs to log in with their username and password to access the application home screen 12.

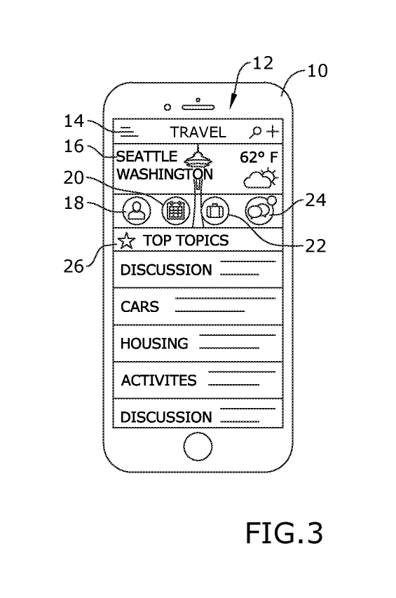

After logging in, or completing their profile, the user will be taken to a system homepage 12 or home screen, presented on the GUI, such as that shown in reference to FIG. 3. The home screen 12 is configured to be dynamically generated based upon the location of the user's device 10. Utilizing the device's GPS/location, the application will determine where the user is located and display a present location banner 16 on the home screen 12. The location banner 16 may include a picture associated with that location. The picture may, for example, be an iconic landmark associated with the particular city or geographic area. Alternatively, the picture may be a photograph associated with a specific location of the device, such as a stadium, a restaurant, a museum, a hotel, an airport, or the like. In addition, location banner 16 of the UI 12 may be configured to present an indication of a current weather condition corresponding to the determined location. It may also provide a textual material to describe the location.

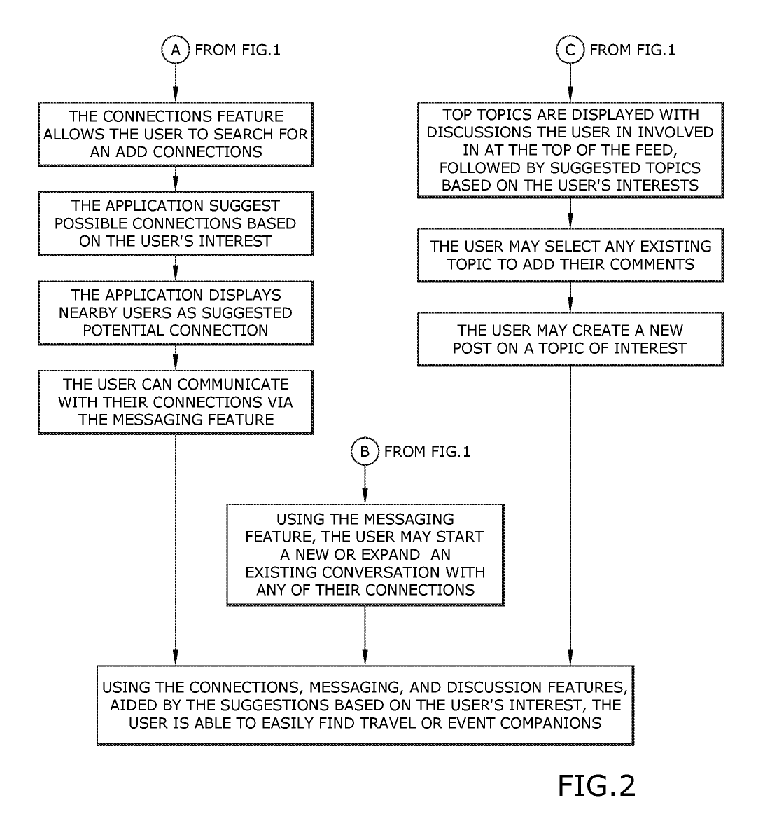

The UI 12 may also present a plurality of feature selection controls to access a plurality of functionality modules of the application. The functionality modules may include one or more of a topics module, the profile management module, a book hotel module, a connections module, a calendar module, and view/create new post module. For example, selection of a connections control 18 launches the connections module that helps the user manage and interact with one or more contacts, as shown from process A of FIG. 2, continued from FIG. 1. The user can choose to add, search, and message their contacts from this feature.

The suggestions based upon interests derived from the AI module will present suggested connections for the user to consider. The connections module may also be configured to display other users that may be nearby, based upon their current reported location that could then become a potential connection. The user may then utilize the functionality provided by the messaging module to invite one or more connections or potential connections to one of a travel destination, an event, or a relocation place.

The messaging module, indicated in process B of FIG. 2, may be activated from within other modules, and may also be accessed directly from the home screen 12 via the messaging control 24. Using the messaging module, the user may start a new conversation, or may join or expand upon an existing conversation with any of their connections. The messages module may also be configured as a stand-alone messaging 24 system of the app.

A top topics module provides functionality for a top topics feed on the homepage 12. Top topics may be displayed with one or more discussions the user may be involved in at the top of the feed. The AI module, may also provide suggested topics based upon the user's interests. Top topics may include a variety of subjects, such as: activities, housing, wanted, hotel, transportation, and discussion. The top topics process flow is indicated in process C of FIG. 2. Users can create a new post and may comment on existing posts on any one or more of these topics. This allows the potential for virtually anything to be accomplished relating to travel and relocating. Any post that the user is involved in will be at the top of the feed as well as potential posts they would be interested in—suggestions based upon on interests generated by the AI module.

Referring back to the next process in FIG. 1, is the user has decided to take a trip, the UI 12 allows the user to select a book a hotel control 22 right on the app. The book hotel module asks the user where their intended destination is, desired dates, number of rooms, and number of adults/children. Once all of the information is entered, the feature will give the user a list of selected hotels at that location, while also giving them offered and discounted rates so they can book a room immediately on the app. The application then automatically uploads the trip, and associated booking information, into a calendar within the app.

A calendar control 20 on the UI 12 may also be utilized to activate the calendar feature. The calendar module permits the user to view their upcoming trip dates, while also allowing them to add everyday events.

In addition to the foregoing controls and modules, the UI also provides a menu control 14 that allows the user to set options for application management module. The application management module includes the user be able to: share the app (via Facebook & Twitter), sign out of the app, view previous and current hotel bookings, and access the settings of the app. The settings aspect of app management module allows the user to make changes to their profile, profile answers, password, message notifications and to block or unblock other users. Once enough content is present, the suggestions based upon the AI interests feature (3) will make suggestions to the user, based on their behavior within the app.

The additional features on the app help the user move forward with travel plans such as booking a hotel and blocking out their schedule. However, the ultimate goal here is to find a travel/event companion. This software is designed to solve the difficulty of locating such people. And with featuring the suggestions based upon interests programming (Artificial Intelligence), it makes something that was once extremely difficult relatively easy.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. An application user interface for a mobile computing device, comprising:
a location banner dynamically presenting a visual image of a landmark based on a determined geographic location of the mobile computing device and a current weather summary corresponding to the determined geographic location;
a control banner displaying a plurality of control buttons, each of the plurality of control buttons providing user access to a contacts module, a calendar module, a book hotel module; and a messaging module; and
a top topics banner displaying a plurality of topics of interest to the user, based on comparison of a user profile and an artificial intelligence (AI) module.

2. The application user interface of claim 1, wherein the visual image provides a background for the location banner and the control banner.

3. The application user interface of claim 1, further comprising:
a contacts module presenting one or more possible connections based upon the user profile and recommendations by the AI module.

4. The application user interface of claim 3, wherein the contacts module is configured to permit the user to select and message a companion to invite them to one or more of: a travel destination, an event, or a relocation place.

5. The application user interface of claim 4, wherein the contacts module is configured to provide functionality to display one or more potential companions based on the determined geographic location of the user and an associated geographic location of the one or more potential companions.

6. The application user interface of claim 5, wherein the booking module provides functionality to book a hotel room from one of a plurality of destination hotels.

7. A system for connecting a community of users who are seeking a travel companion, comprising:
a computer; and
a program product comprising machine-readable program code for causing, when executed, the computer to perform the following process steps:
determining a geographic location for the computer;
locating a visual image of a landmark associated with the geographic location;
determining a current weather condition of the geographic location;
displaying a dynamically updated location banner on a display of the computer, the location banner presenting the visual image of the landmark and a summary of the current weather condition;
displaying a control banner having a plurality of control buttons, each of the plurality of control buttons providing user access to a contacts module, a calendar module, a book hotel module; and a messaging module; and
displaying a top topics banner having a plurality of topics of interest to the user, based on comparison of a user profile and an analysis of the user's behavior when interacting with the system.

8. The system of claim 7, further comprising:
responsive to an activation of a contacts control button, presenting one or more possible connections based upon the user profile and the analysis of the user's behavior.

9. The system of claim 8, further comprising:
responsive to a selection of a connection providing a messaging module permitting the user to message a companion to invite them to one or more of: a travel destination, an event, or a relocation place.

10. The system of claim 9, further comprising:
displaying one or more potential companions based on the geographic location and an associated geographic location of the one or more potential companions.

11. The system of claim 10, further comprising:
presenting a booking module;
receiving a plurality of booking parameters;
presenting a destination hotel corresponding to the plurality of booking parameters.

12. The system of claim 11, further comprising:
receiving a selection of a destination hotel.

13. The system of claim 12, further comprising:
booking a room at the destination hotel selection.
